(19) United States
(12) Patent Application Publication
(10) Pub. No.: US 2010/0221082 A1
(43) Pub. Date: Sep. 2, 2010

(54) MACHINE TOOL DEVICE, MACHINE TOOL AND METHOD OF MANUFACTURING A MACHINE TOOL DEVICE

(75) Inventors: Moshe Israel Meidar, New York, NY (US); Wolfgang Horn, Goeppingen (DE); Markus Gunzenhauser, Boehmenkirch (DE); Mathias Wagner, Ditzingen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: MAG Powertrain GmbH

(21) Appl. No.: 12/696,818

(22) Filed: Jan. 29, 2010

Related U.S. Application Data
(63) Continuation of application No. PCT/EP2008/060646, filed on Aug. 13, 2008.

(30) Foreign Application Priority Data
Sep. 7, 2007 (DE) 10 2007 044 289.2

(51) Int. Cl. B23Q 11/00; B23Q 1/01; B23P 11/00

(52) U.S. Cl. 409/137; 408/56; 29/57; 29/428

(57) ABSTRACT

In order to improve a machine tool device, comprising a machine bed with at least one receiving area for receiving chips produced during the machining of a workpiece, and at least one discharging device for discharging the chips from the receiving area, so that it is usable with flexibility, it is proposed that the at least one discharging device comprise at least one conveying device for conveying the chips from the receiving area and/or at least one flushing device for flushing the chips out of the receiving area and/or at least one suction device for evacuating the chips from the receiving area by suction, and that the machine bed comprise at least one first machine bed section for the arrangement of the conveying device, at least one second machine bed section for the arrangement of the flushing device and at least one third machine bed section for the arrangement of the suction device, so that the machine bed is adapted for selective equipment with the conveying device and/or the flushing device and/or the suction device.

### CROSS-REFERENCE TO RELATED APPLICATIONS

This application is a continuation of International Patent Application Number PCT/EP2008/060646, filed on Aug. 13, 2008, which claims priority to German Patent Application Number 10 2007 044 289.2, filed Sep. 7, 2007, both of which are incorporated herein by reference in their entirety and for all purposes.

### FIELD OF THE INVENTION

The present invention relates to a machine tool device, comprising a machine bed with at least one receiving area for receiving chips produced during the machining of a workpiece, and at least one discharging device for discharging the chips from the receiving area. The machine bed of such a machine tool device serves for the arrangement of fixed or movable parts of a machine tool, for example, a workpiece support device and/or a tool support device. The receiving area of the machine bed serves to receive chips produced during the machining of a workpiece. From there the chips can be discharged from the receiving area with the aid of the discharging device.

### BACKGROUND OF THE INVENTION

A bed for a machine tool is known from U.S. Pat. No. 4,955,770, which comprises a hole structure, so that chips or oil from the bed can drop from a working area into a hole.

A chip flushing apparatus is known from U.S. Pat. No. 5,113,558.

A machine frame of modular construction is known from DE 101 44 028 A1.

A machine tool for metal cutting comprising a collecting system for chips and liquids disposed below the working area is known from DE 100 41 355 A1. The collecting system comprises a pan with a transverse groove, a chip conveyor arranged in the transverse groove and having a spiral-shaped conveyor element, a liquid collector on one side wall of the pan, and a chip outlet arranged on its other side wall at the outlet end of the chip conveyor. Arranged in the interior of the spiral-shaped conveyor element is an elongated screen element, which extends over at least part of the length of the conveyor element and terminates at the liquid collector.

A chip conveyor is known from DE 295 18 984 U1 for evacuating chips produced during the machining of a workpiece from a chip-removing manufacturing machine having integrated in the manufacturing machine a conveyor channel which comprises in the working area of the manufacturing machine a collecting device for the accumulating chips, by means of which the chips are conducted to the conveyor channel. In the area of the collecting device of the chip conveyor, a chip-comminuting device is provided for comminuting the chips produced during the workpiece machining of a workpiece before they enter the conveyor channel for evacuation from the manufacturing machine.

### SUMMARY OF THE INVENTION

In accordance with the invention, a machine tool device is provided, which is usable with flexibility.

In accordance with an embodiment of the invention, the at least one discharging device comprises at least one conveying device for conveying the chips from the receiving area and/or at least one flushing device for flushing the chips out of the receiving area and/or at least one suction device for evacuating the chips from the receiving area by suction, and the machine bed comprises at least one first machine bed section for the arrangement of the conveying device, at least one second machine bed section for the arrangement of the flushing device and at least one third machine bed section for the arrangement of the suction device, so that the machine bed is adapted for selective equipment with the conveying device and/or the flushing device and/or the suction device.

The machine tool device according to the invention makes it possible to equip a machine bed selectively with a conveying device and/or a flushing device and/or a suction device. In this way, with the aid of the same machine bed, a machine tool device can be provided, which can be selectively prepared for a machine tool for dry machining and/or for wet machining of a workpiece by a corresponding discharging device for removal of the chips from the receiving area being selected and by this being arranged on a corresponding machine bed section of the machine bed.

Moreover, the machine tool device according to the invention makes it possible to also equip a machine bed with a plurality of different discharging devices. For example, the discharging of the chips from the receiving area by a mechanically operating conveying device can be aided by the machine bed being additionally equipped with a flushing device and/or a suction device.

When the machine bed is equipped with a conveying device, the machine tool device is suitable for both dry and wet machining of a workpiece. When the machine bed is equipped with a flushing device, the machine tool device is particularly well-suited for wet machining of a workpiece. When the machine bed is equipped with a suction device, the machine tool device is particularly well-suited for dry machining of a workpiece.

The first machine bed section advantageously comprises the receiving area. As a result, the conveying device can be arranged in the receiving area, so that it can convey the chips out of the receiving area.

In particular, it is advantageous for the receiving area to be groove-shaped. This enables simple introduction of the chips produced on a workpiece into the receiving area. A groove-shaped receiving area also enables simple discharge of the chips from the receiving area.

It is particularly preferred for a bottom delimitation of the receiving area to be inclined in relation to an installation plane of the machine bed. Removal of the chips from the receiving area can be aided by this inclination.

In accordance with an embodiment of the invention, the first machine bed section comprises at least one aperture by means of which the receiving area is connected with an environment of the machine tool device. Such an aperture enables the chips to be transported out of the receiving area into the environment of the machine tool device. The aperture also enables particularly easy coupling of the conveying device to a drive device.

The conveying device is advantageously adapted for insertion via the aperture into the receiving area. This enables particularly easy assembly of the machine tool device.

It is preferred for the conveying device to comprise at least one screw conveyor. Such a screw conveyor enables continuous and reliable evacuation of the chips out of the receiving area.

Furthermore, it is expedient for the conveying device to comprise at least one conveyor belt. A large chip evacuation area can be provided with the aid of such a conveying device.

The machine tool device advantageously comprises at least one drive device for driving the conveying device, which, in particular, is adapted for arrangement on the machine bed. This enables a compact machine tool device design.

It is preferred for the second machine bed section to comprise at least one wall element which delimits the receiving area. In this way, the flushing device can be arranged in the immediate vicinity of the chips to be flushed out of the receiving area, so that a particularly good flushing effect can be obtained.

Furthermore, it is advantageous for the machine bed to be reinforced by the wall element. Such a wall element simultaneously serves to delimit the receiving area and to reinforce a supporting structure of the machine bed.

The flushing device advantageously comprises at least one nozzle for introducing at least one flushing fluid into the receiving area. With the aid of such a nozzle, a stream of flushing fluid can be generated, which enables flushing of the receiving area for evacuation of the chips.

In particular, the flushing fluid is a liquid and/or compressed air.

Furthermore, it is preferred for the third machine bed section to comprise the receiving area. In this way, at least parts of the suction device can be arranged in the receiving area.

It is preferred for the third machine section to comprise an additional area which is integrated into the machine bed. In this way, an additional area for arrangement of the suction device or parts of the suction device can be provided with the aid of the machine bed.

The machine tool device preferably comprises at least one passage for connection of the receiving area and the additional area. Such a passage enables a fluidic connection between the receiving area and the additional area, so that chips can be evacuated out of the receiving area through the passage into the additional area.

It is preferred for the receiving area and the additional area to extend in directions parallel to each other. This enables a space-saving arrangement of the two areas.

It is particularly preferred for the receiving area to be arranged above the additional area in relation to the direction of gravity. In this way, evacuation of the chips by suction from the receiving area into the additional area is assisted by the action of gravity.

The suction device preferably comprises at least one chip guiding element which is adapted for insertion into the receiving area. Such a chip guiding element enables a guiding path to be prescribed for a chip falling into the receiving area and/or for a chip to be evacuated from the receiving area by suction.

The chip guiding element is advantageously funnel-shaped. This enables a large chip introduction area and a small chip discharge area to be provided. The reduction in size of the chip discharge area has the advantage that a higher suction capacity can be provided in the area of the chip discharge area.

Furthermore, it is expedient for the suction device to comprise a least one suction line which is in fluidic connection with the receiving area. Such a line enables transportation of the chips to be discharged along the machine bed. In particular, it is advantageous for the suction line to be arranged in the additional area of the machine bed.

If the cross-sectional area of the suction line increases, seen in a direction of chip evacuation by suction, it is possible to provide identical suction capacities at different suction locations along the suction line.

The machine bed is preferably made from at least one cast part. In this way, parts of the machine bed, for example, a delimitation of the receiving area and/or a delimitation of the additional area, can be produced in a simple way.

The invention further relates to a machine tool with a machine tool device described hereinabove. In particular, the machine tool is a machining center.

It is preferred for the at least one receiving area to be at least of the same length as a working area of the machine tool. This enables reliable processing of chips produced during the machining of a workpiece independently of the positioning of the workpiece relative to the receiving area.

In accordance with an embodiment of the invention, the machine tool comprises a plurality of slides movably guided on the machine bed for holding at least one workpiece and/or at least one tool, with each slide having at least one receiving area of its own associated with it, and each receiving area having at least one discharging device of its own associated with it. This enables independent discharging of the chips from each of the receiving areas.

The invention further relates to a method of manufacturing a machine tool device, comprising a machine bed with at least one receiving area for receiving chips produced during the machining of a workpiece.

In accordance with the invention, a method of manufacturing a machine tool device is indicated, which is usable with flexibility.

In accordance with an embodiment of the invention, in a method of manufacturing a machine tool device, such as a device comprising a machine bed with at least one receiving area for receiving chips produced during the machining of a workpiece, at least one conveying device for conveying the chips out of the receiving area, at least one flushing device for flushing the chips out of the receiving area and at least one suction device for evacuating the chips out of the receiving area by suction are provided, and the machine bed is selectively equipped with the conveying device and/or the flushing device and/or the suction device.

The advantages of the method according to the invention have already been explained hereinabove in conjunction with the embodiments of the device according to the invention.

Further features and advantages of the invention are the subject matter of the following description and the drawings of preferred embodiments.

### BRIEF DESCRIPTION OF THE DRAWINGS

FIG. 1 shows a perspective view of an embodiment of a machine tool with a machine bed;

FIG. 2 shows a perspective view of the machine bed from FIG. 1;

FIG. 3 shows a view corresponding to FIG. 2 from a rearward perspective;

FIG. 4 shows a sectional view of the machine bed from FIG. 2 in accordance with a sectional plane denoted by IV therein;

FIG. 5 shows a perspective view of an embodiment of a machine tool device with a machine bed and with a discharging device;

FIG. 6 shows a perspective view of a further embodiment of a machine tool device with a machine bed and with a discharging device;

FIG. 7 shows a perspective view of the machine tool device shown in FIG. 6 in accordance with a sectional plane denoted by VII therein;

FIGS. 8a to 8c show sectional side views of three further embodiments of a machine tool device; and

FIGS. 9a to 9d show sectional side views of four further embodiments of a machine tool device.

### DETAILED DESCRIPTION OF THE INVENTION

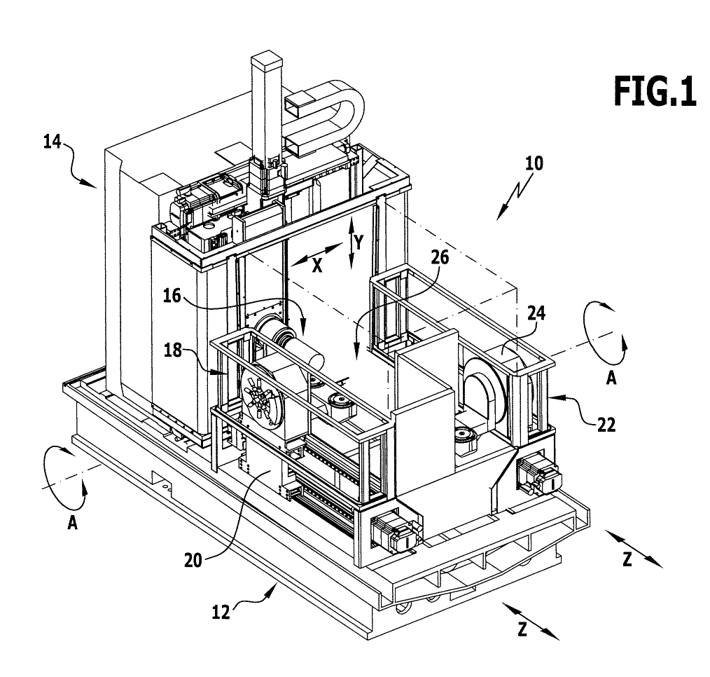

An embodiment of a machine tool according to the invention, shown in FIG. 1 and denoted by 10 therein, comprises a machine bed 12. The machine tool 10 is installed on a base with the aid of the machine bed 12.

A machine frame 14 in the form of a stand or a portal is arranged on the machine bed 12.

The machine tool 10 comprises a tool support device 16 which is mounted on the machine frame 14 and driven for movement in an x-direction and in a y-direction perpendicular thereto.

The machine tool 10 also comprises a first workpiece support device 18 in the form of a first slide 20 and a second workpiece support device 22 in the form of a slide 24.

The slides 20 and 24 are mounted on the machine bed 12 and driven for displacement along a respective z-axis associated therewith.

A workpiece held on the workpiece support device 18 and/or the workpiece support device 22 can be machined by chip removal with the aid of a tool held on the tool support device 16. This machining takes place in a working area 26 arranged above the machine bed 12 in the direction of gravity.

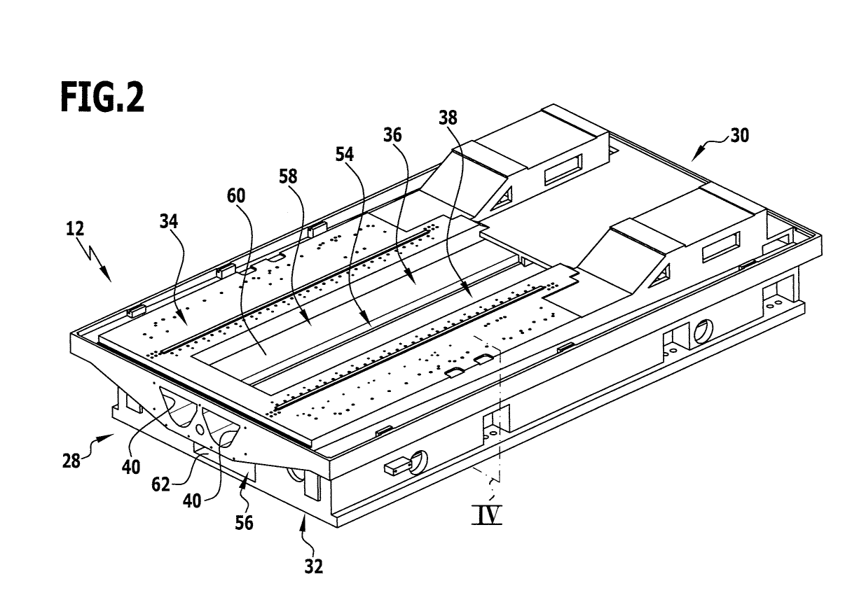

The machine bed 12 of the machine tool 10 is shown in FIG. 2. The machine bed 12 extends between a front end 28 and a rear end 30. The machine bed 12 comprises an underside 32 which forms an installation plane for installation of the machine bed 12 on a base. The machine bed 12 also comprises an upper side 34 for arrangement of the machine frame 14 and the workpiece support devices 18, 22 (cf. FIG. 1) thereon.

The machine bed 12 comprises at least one receiving area. The machine bed 12 shown in the drawings comprises two receiving areas 36 and 38. The receiving areas 36 and 38 extend in each case between the front end 28 and the rear end 30 of the machine bed 12.

The receiving areas 36, 38 open at the front end 28 of the machine bed 12 in each case into an aperture 40 by means of which the receiving areas 36, 38 are connected in each case with an environment of the machine bed 12. Furthermore, the receiving areas 36 and 38 open at the rear end 30 of the machine bed 12 in each case into an aperture 42 for connection of the receiving areas 36, 38 with the environment of the machine bed 12.

The receiving areas 36, 38 are groove-shaped. The receiving areas 36, 38 extend in directions parallel to the z-directions of the machine tool 10. The receiving areas 36, 38 are open in the upward direction in an area associated with the working area 26 of the machine tool 10.

The receiving areas 36, 38 are delimited by wall elements 46, 48 extending in each case at an angle to one another. The wall elements form a V-shaped or U-shaped groove profile.

The wall elements 46, 48 pass in a connecting area 50 into one another. The connecting areas 50 form on their side facing the receiving areas 36, 38 a respective bottom delimitation 52 of a receiving area 36, 38.

It is preferred for the bottom delimitation 52, seen between the front end 28 and the rear end 30 of the machine bed 12, to be inclined relative to an installation plane of the machine bed 12. This facilitates the removal of chips from the receiving area 36, 38 into an environment of the machine bed 12. The installation plane can be defined by the underside 32 of the machine bed 12 or by means of separate installation elements, not shown. The machine bed 12 can, for example, be installed by means of three installation elements (not shown in the drawings) in order to enable a three-point installation of the machine bed 12.

The wall element 48 of the receiving area 36 and the wall element 46 of the receiving area 38 jointly form a separating device 54 for separation of the receiving areas 36, and 38. The separating device 54 enables chips contained in the receiving areas 36, 38 to be separately discharged in each case from these receiving areas.

The machine bed 12 comprises an additional area 56. In particular, the additional area is of substantially cuboidal configuration.

The additional area 56 extends between the front end 28 and the rear end 30 of the machine bed 12. The additional area 56 and at least one of the receiving areas 36, 38 preferably extend in an at least approximately parallel direction. Furthermore, it is preferred for the additional area 56 to be arranged below at least one receiving area 36, 38 in the direction of gravity.

The machine bed 12 comprises a plurality of machine bed sections for the arrangement of different discharging devices for the discharge of chips from the at least one receiving area 36, 38.

The machine bed 12 comprises a first machine bed section 58. This is formed, for example, by at least one receiving area 36, 38. The first machine bed section serves for the arrangement of a conveying device by means of which chips can be mechanically conveyed out of the receiving area.

The machine bed 12 comprises a second machine bed section 60. This is formed, for example, by at least one wall element 46, 48 of at least one receiving area 36, 38. This second machine bed section enables the arrangement of a flushing device by means of which a flushing fluid can be introduced into at least one of the receiving areas 36, 38, so that chips contained in the receiving area 36, 38 can be flushed out of it.

The machine bed 12 also comprises a third machine bed section 62. The third machine bed section comprises, for example, the additional area 56 and/or at least one receiving area 36, 38. The third machine bed section enables the arrangement of a suction device for evacuation of the chips by suction from at least one of the receiving areas 36, 38.

The aforementioned machine bed sections 58, 60 and 62 enable the machine bed 12 to be selectively equipped with a mechanically operating conveying device and/or with a flushing device and/or with a suction device.

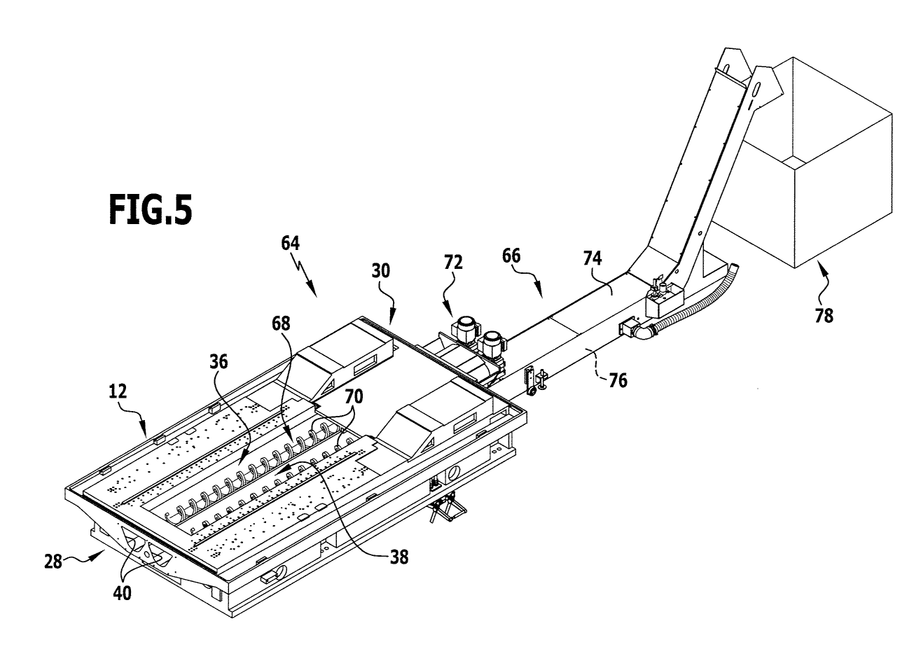

FIG. 5 shows an embodiment of a machine tool device denoted by 64, which comprises the machine bed 12 and a discharging device 66 in the form of a conveying device 68.

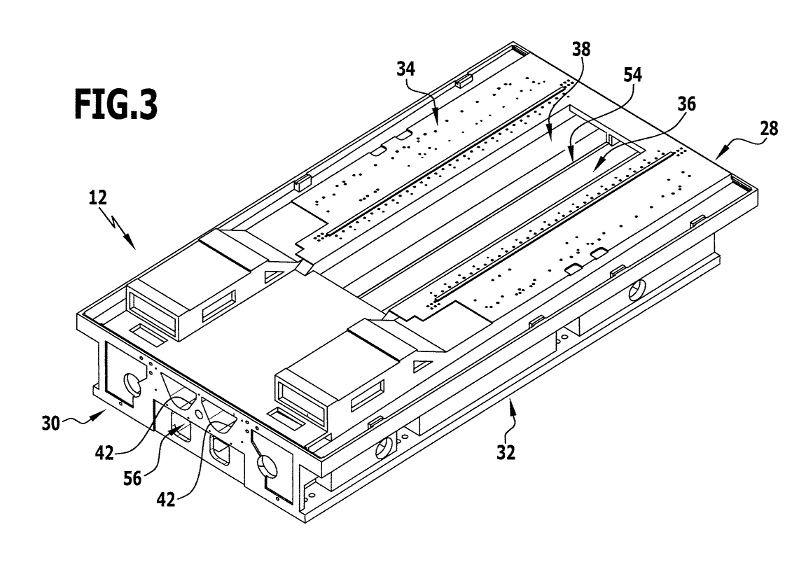

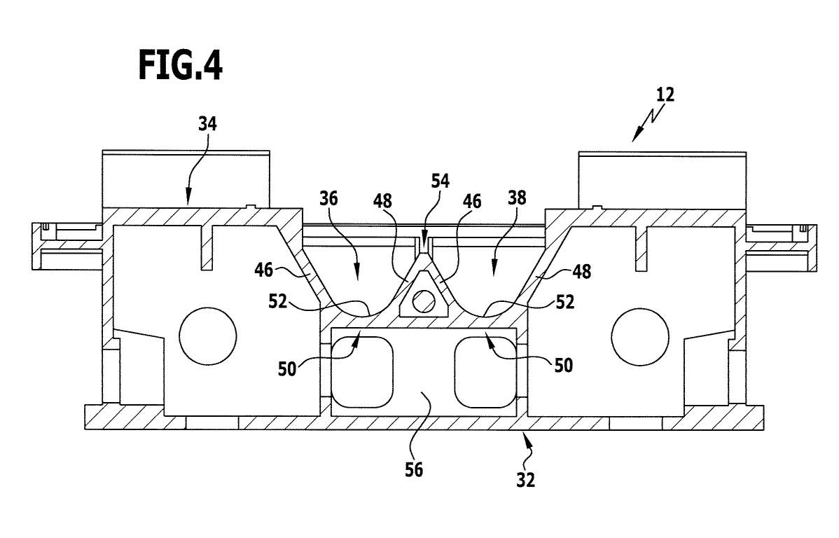

The conveying device 68 comprises at least one screw conveyor 70 which is arranged in a receiving area 36, 38. The screw conveyor 70 extends from the front end 28 of the machine bed 12 to the rear end 30 of the machine bed 12. There the rear end of the screw conveyor 70 passes through the aperture 42 of a receiving area 36, 38, which is shown in FIG. 3. At this end of the screw conveyor 70, the latter is driven by a drive device 72. The drive device 72 causes the screw conveyor 70 to rotate, so that chips contained in a receiving area 36, 38 are conveyed in the direction towards the rear end 30 of the machine bed 12.

The aperture 42 of each receiving area 36, 38, is in fluidic connection with a housing 74 which is preferably closed circumferentially, so that the chips can get from the receiving area 36, 38 into the interior of the housing 74. There is arranged in the housing 74 a conveyor belt 76 which removes chips discharged from a receiving area 36, 38, for example, into a collection container 78.

In the embodiment shown in FIG. 5, the drive device 72 is arranged at the rear end 30 of the machine bed 12. In an alternative embodiment, not shown in the drawings, it is possible for the drive device 72 to be arranged at the front end 28 of the machine bed 12 and for the screw conveyors 70 to interact with the drive device 72 via the apertures 40.

In both described variants for arrangement of the drive device 72, the chips contained in a receiving area 36, 38 can be disposed of both in a conveying direction towards the rear end 30 of the machine bed 12 and in a conveying direction towards the front end 28 of the machine bed 12. Reversal of the conveying direction is brought about by a simple switching-over of the direction of rotation of a screw conveyor 70 by corresponding reversal of the drive device 72.

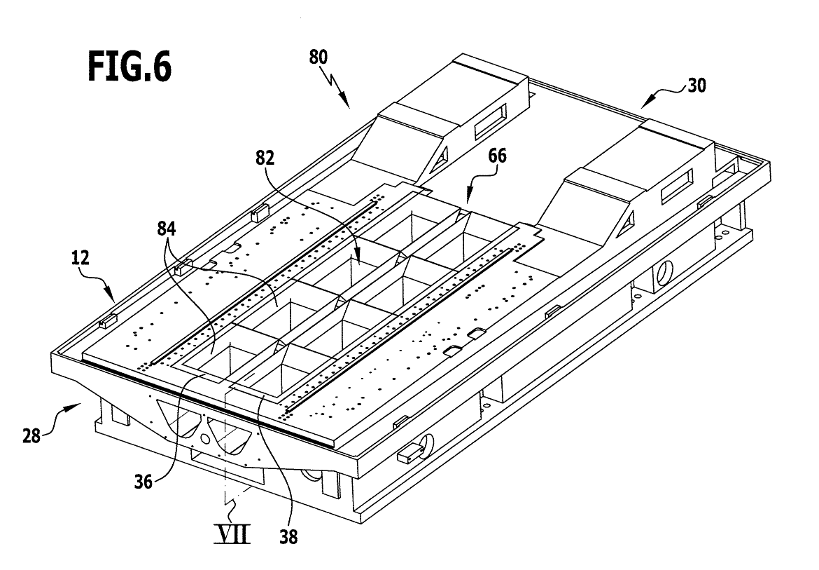

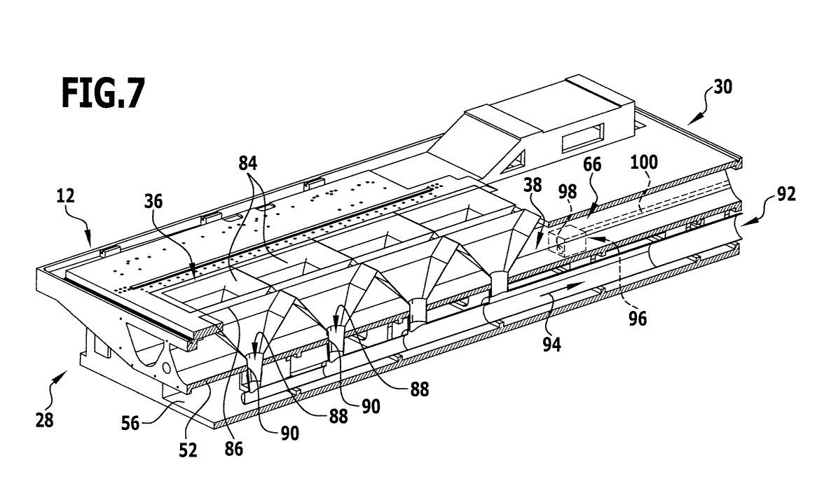

A machine tool device 80 shown in FIGS. 6 and 7 comprises the machine bed 12 which is equipped with a discharging device 66 in the form of a suction device 82.

The suction device 82 comprises at least one chip guiding element 84 adapted for arrangement in a receiving area 36, 38. The at least one chip guiding element 84 can be arranged, in particular, inserted in the at least one receiving area 36, 38.

The at least one chip guiding element 84 is preferably of funnel-shaped configuration, so that an extensive inlet 86 is formed for chips falling into a chip guiding element 84. By virtue of the funnel-shaped configuration of a chip guiding element 84, the latter tapers in the direction towards an outlet 88.

The outlet 88 of a chip guiding element 84 extends through a passage 90 arranged in the bottom delimitation 52 of a receiving area 36, 38. With the aid of the passage 90 a connection is made between the at least one receiving area 36, 38 and the additional area 56 arranged below it in the direction of gravity.

There is arranged in the additional area 56 a suction line 92 which is in fluidic connection with a plurality of outlets 88 of several chip guiding elements 84.

The suction line 92 expands, seen in a direction 94 of chip evacuation by suction, so that the same suction capacity can be made available in each case at various outlets 88 of various chip guiding elements 84.

The suction line 92 opens into the rear end 30 of the machine bed 12, so that chips can be evacuated by suction in the direction towards the rear end 30. Alternatively thereto, the suction line 92 can also open into the front end 28 of the machine bed 12, so that chips can be evacuated by suction in the direction towards the front end 28.

Alternatively or supplementarily to a discharging device 66 configured as a conveying device 68 or alternatively to a discharging device 66 configured as a suction device 82, the discharging device 66 can also comprise a flushing device 96. Such a flushing device is shown in broken lines in FIG. 7. This flushing device 96 can be positioned, for example, at the bottom delimitation 52 of a receiving area 36, 38.

The flushing device 96 can—as indicated in FIG. 7—be arranged so that a stream of flushing fluid is directed towards the front end 28 of the machine bed 12. Alternatively thereto, the flushing device 96 can be arranged so that it generates a stream of flushing fluid directed towards the rear end 30 of the machine bed 12.

Preferably, the flushing device 96 comprises at least one nozzle 98 with which a flushing fluid can be introduced into the receiving area 36, 38, so that the latter can be flushed and chips contained in the receiving area can be conveyed out of it.

For supplying the flushing device 66 with a flushing fluid, for example, a liquid and/or compressed air, the flushing device 96 comprises a flushing fluid supply line 100. This can be fed by an external flushing fluid source which can be arranged outside of the machine bed 12 or also attached to it.

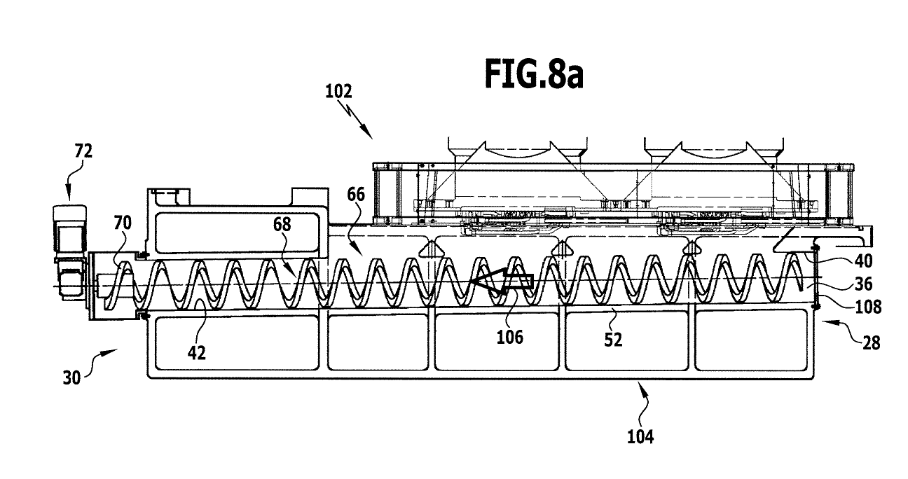

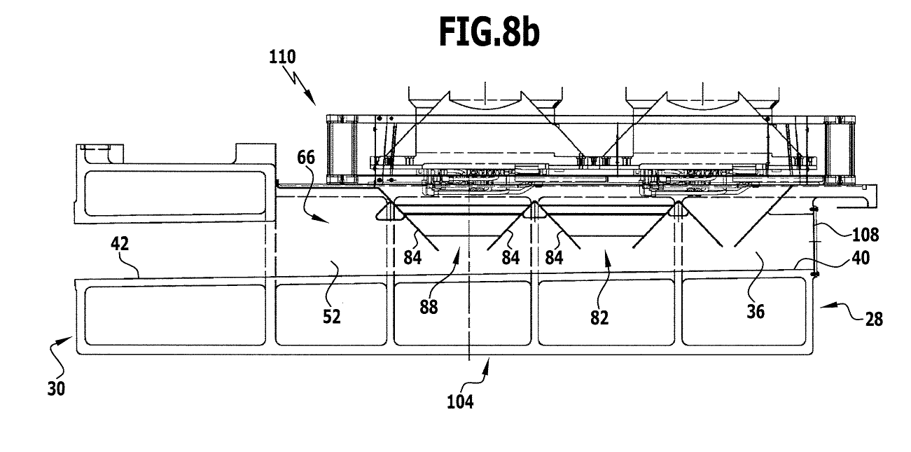

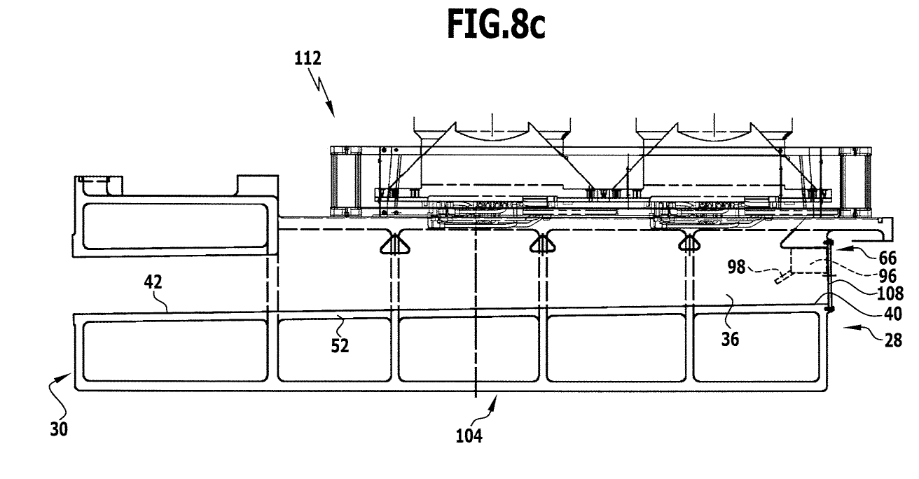

FIGS. 8a, 8b, and 8c show further embodiments of a machine tool device which is denoted by 102 in FIG. 8a, by 110 in FIG. 8b and by 112 in FIG. 8c.

The machine tool devices 102, 110 and 112 comprise an identical machine bed 104.

The machine bed 104 has a structure which is similar to that of the machine bed 12. In this connection, reference is to be had to the above description of the structure and the mode of operation of the machine bed 12.

The machine bed 104 differs from the machine bed 12 in that there is no separate additional area 56 provided for the arrangement of a discharging device 66. Furthermore, the machine bed 104 comprises only one receiving area 36 which, in particular, is arranged at the center.

The bottom delimitation 52 of the receiving area 36 of the machine bed 104 is downwardly inclined in a chip conveying direction 106 indicated in FIG. 8a with respect to the direction of gravity. This facilitates the removal of chips contained in the receiving area 36 with the aid of the discharging device 66.

The machine tool device 102 shown in FIG. 8a is equipped with a discharging device 66 in the form of a conveying device 68. The removal of the chips takes place in the direction 106 towards the rear end 30 of the machine bed 104. The end of the receiving area 36 that faces the front end 28 of the machine bed 104 is closed by a cover 108.

The machine tool device 110 shown in FIG. 8b differs from the machine tool device 102 in that it comprises a discharging device 66 in the form of a suction device 82. The suction device 82 comprises a plurality of funnel-shaped chip guiding elements 84 arranged in the receiving area 36.

In contrast to the embodiment, shown with reference to FIGS. 6 and 7, of a suction device 82 of the machine tool device 80, the outlets 88 of the chip guiding elements 84 do not open into an additional area 56 or into a suction line 92 but into the receiving area 36.

Therefore, chips to be disposed of from the receiving area 36 can be evacuated by suction via the aperture 42 at the rear end 30 of the machine bed 104. Alternatively thereto, the chips can also be evacuated by suction via the aperture 40 at the front end of the machine bed 104 if there is no cover 108 provided in this area.

In the embodiment, shown in FIG. 8c, of a machine tool device 112, a discharging device 66 in the form of a flushing device 96 is provided. This is arranged in the receiving area 36 in the area of the aperture 40 of the machine bed 104. The flushing device 96 preferably comprises at least one nozzle 98 for introducing a flushing fluid into the receiving space 36.

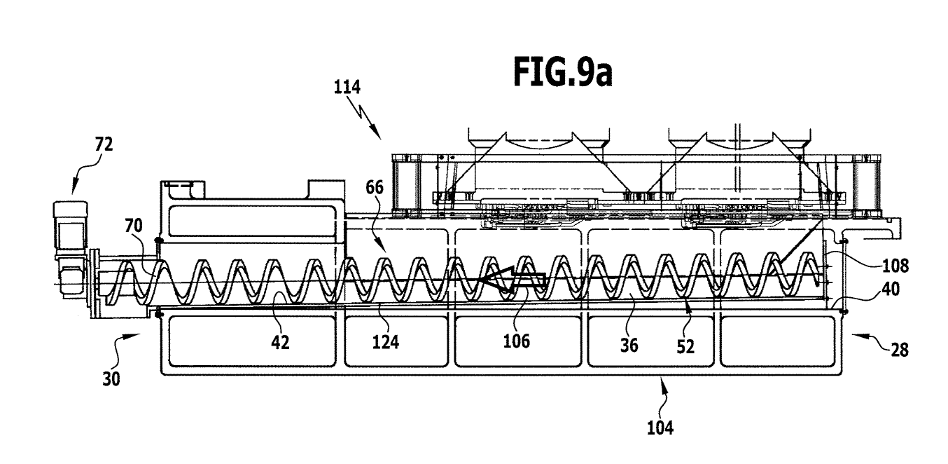

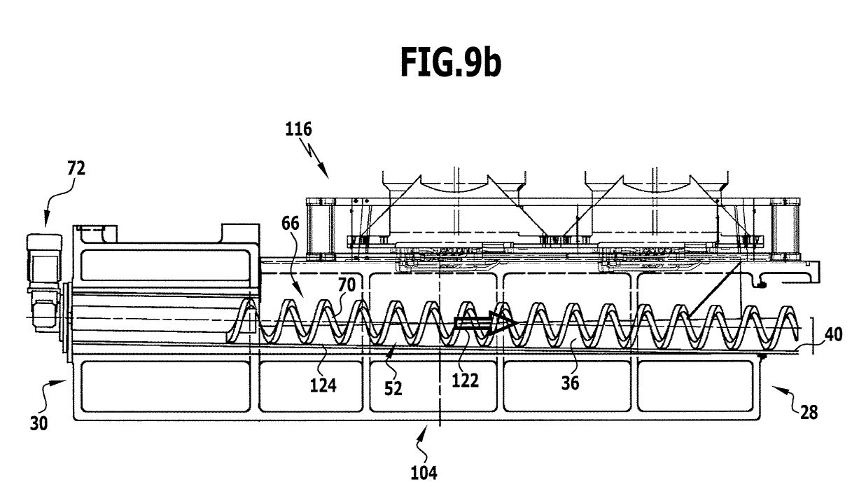

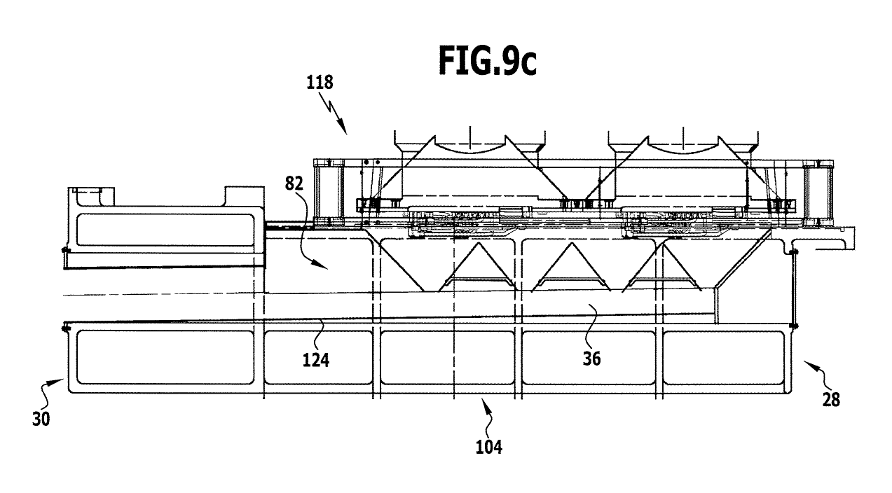

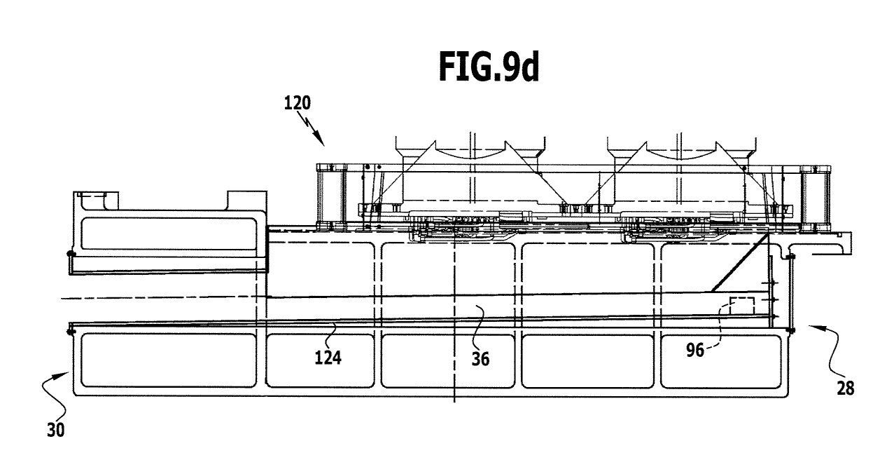

The machine tool devices 114, 116, 118 and 120 shown in FIGS. 9a, 9b, 9c and 9d differ from the machine tool devices 102, 110 and 112 shown in FIGS. 8a to 8c in that the receiving area 36 is not delimited by parts of the wall structure of the machine bed 104 but by means of delimiting elements 124 which are separate from the latter. These are configured as sheet metal parts, for example. They form at least one bottom delimitation 52 of a receiving area 36.

With the aid of the separate delimiting elements 124, it is possible to vary the inclination of the bottom delimitation 52 of a receiving area 36.

In the machine tool device 114 shown in FIG. 9a, the bottom delimitation 52 is downwardly inclined from a front end 28 towards a rear end 30 of the machine bed 104 in the chip conveying direction 106.

In the embodiment, shown in FIG. 9b, of a machine tool device 116, the chip conveying direction 122 is the reverse of the chip conveying direction 106. Accordingly, at least the bottom delimitation 52 of the receiving area 36 of the machine tool device 116, seen in the chip conveying direction 122, has an inclination in the downward direction from the rear end 30 towards the front end 28 of the machine bed 104. In the machine tool device 116 shown in FIG. 9b, the disposal of the chips does not take place in the area of the rear end 30 (cf. FIG. 9a), but in the area of the front end 28 of the machine bed 104. Accordingly, the machine tool device 116, differently from the machine tool device 114, does not have any cover 108 in the area of the aperture 40.

When separate delimiting elements 124 are used, the machine bed 104 can also be equipped with a suction device 82 (FIG. 9c) and/or with a flushing device 96 (cf. FIG. 9d).

1. Machine tool device, comprising:
a machine bed with at least one receiving area for receiving chips produced during the machining of a workpiece; and
at least one discharging device for discharging the chips from the receiving area;
wherein the at least one discharging device comprises at least one of (i) at least one conveying device for conveying the chips from the receiving area and (ii) at least one flushing device for flushing the chips out of the receiving area and (iii) at least one suction device for evacuating the chips from the receiving area by suction; and
wherein the machine bed comprises (i) at least one first machine bed section for the arrangement of the conveying device, (ii) at least one second machine bed section for the arrangement of the flushing device and (iii) at least one third machine bed section for the arrangement of the suction device, so that the machine bed is adapted for selective equipment with at least one of the conveying device and the flushing device and the suction device.

2. Machine tool device in accordance with claim 1, wherein the first machine bed section comprises the receiving area.

3. Machine tool device in accordance with claim 1, wherein the receiving area is groove-shaped.

4. Machine tool device in accordance with claim 1, wherein a bottom delimitation of the receiving area is inclined in relation to an installation plane of the machine bed.

5. Machine tool device in accordance with claim 1, wherein the first machine bed section comprises at least one aperture by means of which the receiving area is connected with an environment of the machine tool device.

6. Machine tool device in accordance with claim 5, wherein the conveying device is adapted for insertion via the aperture into the receiving area.

7. Machine tool device in accordance with claim 1, wherein the conveying device comprises at least one screw conveyor.

8. Machine tool device in accordance with claim 1, wherein the conveying device comprises at least one conveyor belt.

9. Machine tool device in accordance with claim 1, wherein at least one drive device is provided for driving the conveying device.

10. Machine tool device in accordance with claim 9, wherein the drive device is adapted for arrangement on the machine bed.

11. Machine tool device in accordance with claim 1, wherein the second machine bed section comprises at least one wall element which delimits the receiving area.

12. Machine tool device in accordance with claim 11, wherein the machine bed is reinforced by the wall element.

13. Machine tool device in accordance with claim 1, wherein the flushing device comprises at least one nozzle for introducing at least one flushing fluid into the receiving area.

14. Machine tool device in accordance with claim 13, wherein the flushing fluid is a liquid.

15. Machine tool device in accordance with claim 13, wherein the flushing fluid is compressed air.

16. Machine tool device in accordance with claim 1, wherein the third machine bed section comprises the receiving area.

17. Machine tool device in accordance with claim 1, wherein the third machine bed section comprises an additional area which is integrated into the machine bed.

18. Machine tool device in accordance with claim 17, wherein at least one passage is provided for connection of the receiving area and the additional area.

19. Machine tool device in accordance with claim 17, wherein the receiving area and the additional area extend in directions parallel to each other.

20. Machine tool device in accordance with claim 17, wherein the receiving area is arranged above the additional area in relation to the direction of gravity.

21. Machine tool device in accordance with claim 1, wherein the suction device comprises at least one chip guiding element which is adapted for insertion into the receiving area.

22. Machine tool device in accordance with claim 21, wherein the chip guiding element is funnel-shaped.

23. Machine tool device in accordance with claim 1, wherein the suction device comprises at least one suction line which is in fluidic connection with the receiving area.

24. Machine tool device in accordance with claim 23, wherein the cross-sectional area of the suction line, seen in a direction of chip evacuation by suction, increases.

25. Machine tool device in accordance with claim 1, wherein the machine bed is made from at least one cast part.

26. Machine tool with a machine tool device, said machine tool device comprising:
a machine bed with at least one receiving area for receiving chips produced during the machining of a workpiece; and
at least one discharging device for discharging the chips from the receiving area;
wherein the at least one discharging device comprises at least one of (i) at least one conveying device for conveying the chips from the receiving area and (ii) at least one flushing device for flushing the chips out of the receiving area and (iii) at least one suction device for evacuating the chips from the receiving area by suction; and
wherein the machine bed comprises (i) at least one first machine bed section for the arrangement of the conveying device, (ii) at least one second machine bed section for the arrangement of the flushing device and (iii) at least one third machine bed section for the arrangement of the suction device, so that the machine bed is adapted for selective equipment with at least one of the conveying device and the flushing device and the suction device.

27. Machine tool in accordance with claim 26, wherein the at least one receiving area is at least of the same length as a working area of the machine tool.

28. Machine tool in accordance with claim 26, wherein the machine tool comprises a plurality of slides movably guided on the machine bed for holding at least one of at least one workpiece and at least one tool, wherein each slide has at least one receiving area of its own associated with it, and wherein each receiving area has at least one discharging device of its own associated with it.

29. Method of manufacturing a machine tool device, said machine tool device comprising a machine bed with at least one receiving area for receiving chips produced during the machining of a workpiece;
said method comprising:
providing (i) at least one conveying device for conveying the chips out of the receiving area, (ii) at least one flushing device for flushing the chips out of the receiving area and (iii) at least one suction device for evacuating the chips out of the receiving area by suction; and
selectively equipping the machine bed with at least one of the conveying device and the flushing device and the suction device.
